(19) United States
(12) Patent Application Publication
(10) Pub. No.: US 2025/0162221 A1
(43) Pub. Date: May 22, 2025

(54) VERTICAL MOLDING MACHINE

(71) Applicant: SHENZHEN BEIGONG INDUSTRIAL CO., LTD, SHENZHEN (CN)

(72) Inventor: Zhiqiang CHENG, SHENZHEN (CN)

(21) Appl. No.: 19/031,368

(22) Filed: Jan. 18, 2025

Related U.S. Application Data
(63) Continuation of application No. PCT/CN2023/098560, filed on Jun. 6, 2023.

(30) Foreign Application Priority Data
Jun. 6, 2022 (CN) 202210627333.1

(51) Int. Cl. B29C 45/53; B01F 33/45

(52) U.S. Cl. CPC B29C 45/53; B01F 33/45

(57) ABSTRACT

A vertical molding machine comprises a bottom base, a supporting beam and a top base. An upper end of the supporting beam is connected with the top base, a lower end of the supporting beam is connected with the bottom base, an upper side of the bottom base is connected with a lower side assembly machine, a lower side of the top base is connected with an upper side assembly machine, the upper side assembly machine and the lower side assembly machine are matched for pressing a mold, a plurality of feeding portions are arranged in the lower side assembly machine, the feeding portion is communicated with an upper side of the lower side assembly machine through a material tube, at least one ladling manipulator is mounted on a side surface of the bottom base, and at least one ladle is mounted on each ladling manipulator.

### TECHNICAL FIELD

The present invention relates to the technical field of molding machines, and in particular to a vertical molding machine.

### BACKGROUND OF THE PRESENT INVENTION

A working principle of a molding machine is a technological process of injecting a liquid material into a mold cavity by thrusts of a screw, a plunger, and the like, and then obtaining a product after curing and shaping.

For example, the publication number CN201201038 discloses a rapid molten steel casting and molding machine, which comprises a billet molding mold, a water introduction mold support, an arc-shaped carrier, a steel flowing bottom plate, a concave frame, a pouring pipe, a die assembly oil cylinder and a locking oil cylinder hydraulic system; and a bottom portion of a whole body is the arc-shaped carrier, which supports the steel flowing bottom plate erected on the arc-shaped carrier, the concave frame is mounted on the arc-shaped carrier, which supports the molding mold and the water introduction mold support around the molding mold, and one end of the steel flowing bottom plate is provided with the pouring pipe. The molding mold consists of two half molds of equal size, a number of the molding molds depends on an amount of molten steel, and the molding mold is a combined configuration of a single set of molding molds to multiple sets of molding molds. The invention is suitable for liquid casting of various steel grades to cast billets of various specifications, thus achieving high efficiency, low energy consumption and reuse, and a yield of molten steel reaches above 95%, so that the invention is suitable for various steel-making enterprises.

In the prior art, most molding machines only inject a material into a feeding hole of a mold through a feeding portion, which easily causes a long time required for liquid injection, so as to lead to uneven temperature of a liquid material in front and back portions, resulting in unstable product molding.

### SUMMARY OF THE PRESENT INVENTION

The present invention aims to provide a vertical molding machine to solve the problem that most molding machines are only provided with a single hole for feeding, which easily causes a long time required for liquid injection of the molding machine to a mold, so as to lead to uneven temperature of a liquid material in front and back portions, resulting in unstable product molding, in the prior art.

In order to solve the above technical problem, the present invention adopts the following technical solution.

A vertical molding machine comprises a bottom base, a supporting beam and a top base, wherein an upper end of the supporting beam is connected with the top base, a lower end of the supporting beam is connected with the bottom base, an upper side of the bottom base is connected with a lower side assembly machine, a lower side of the top base is connected with an upper side assembly machine, the upper side assembly machine and the lower side assembly machine are matched for pressing a mold, a plurality of feeding portions are arranged in the lower side assembly machine, the feeding portion is communicated with an upper side of the lower side assembly machine through a material tube, at least one ladling manipulator for filling a liquid material into the feeding portion is mounted on a side surface of the bottom base, and at least one ladle is mounted on each ladling manipulator.

According to a further technical solution, the feeding portion comprises the material tube and a material pushing device, the material pushing device is arranged in the material tube in an up-down sliding manner, the material tube is provided with a solution cavity on an upper side of the material pushing device, and an upper end of the material tube is communicated with an upper side of the lower side assembly machine.

According to a further technical solution, at least one electromagnetic stirring device is mounted on the material tube, the electromagnetic stirring device is mounted on the material tube through a mounting frame, the mounting frame is sleeved on an outer wall of the material tube through a mounting hole, a hole wall of the mounting hole is provided with a mounting groove around the material tube, the electromagnetic stirring device is an annular electromagnetic stirrer, and the annular electromagnetic stirrer is sleeved on the outer wall of the material tube in the mounting groove.

According to a further technical solution, the lower side assembly machine is slidably mounted on the upper side of the bottom base through a sliding table, and one end of the sliding table extends to an outer side of the bottom base.

According to a further technical solution, the upper side assembly machine is connected with the top base through a driving oil cylinder, the driving oil cylinder is arranged in the top base, and an output end of the driving oil cylinder penetrates through the top base downwards and is connected with an upper side of the upper side assembly machine.

According to a further technical solution, a side surface of a body of the molding machine is provided with a ladder, and the driving oil cylinder, the material pushing device, the electromagnetic stirring device and the ladling manipulator are all controlled by a control cabinet.

According to a further technical solution, the mounting frame comprises a frame body and an access plate which are detachably connected, the mounting groove is arranged on the frame body, and the access plate is detachably connected with the frame body on an upper side or a lower side of the frame body for forming an upper groove wall or a lower groove wall of the mounting groove.

According to a further technical solution, a material pushing control module is arranged in the control cabinet, the material pushing device comprises an injection plug head arranged in the material tube in an up-down sliding manner and a driving assembly connected to a lower portion of the material pushing device, and the material pushing control module is in wired or wireless signal connection with the driving assembly; and the driving assembly comprises a screw motor or a plunger pump.

Compared with the prior art, by such arrangement, when some large-scale products need to be processed, the plurality of feeding portions may be arranged in the lower side assembly machine, and meanwhile, in cooperation with a plurality of ladling manipulators and a plurality of ladles, the feeding portions can be filled with the liquid material at the same time through the plurality of ladles, so that a temperature of the liquid material in each feeding portion is the same, without a temperature difference caused by a time difference. By arranging the feeding portion on the bottom base, the mold can be injected with the material from bottom to top, so that air will not be wrapped in the material, and air pores generated in a molded product are reduced. Further, the plurality of feeding portions inject the material into the mold at the same time, which is equivalent to dividing the mold into small areas for filling, and a pressure is more uniform.

### DESCRIPTION OF THE DRAWINGS

FIG. 1 is a stereoscopic diagram of a vertical molding machine according to the present invention.

FIG. 2 is a stereoscopic diagram of a feeding portion of the vertical molding machine according to the present invention.

FIG. 3 is a sectional view of the feeding portion of the vertical molding machine according to the present invention.

Reference numerals: 1 refers to bottom base, 2 refers to supporting beam, 3 refers to top base, 4 refers to lower side assembly machine, 5 refers to upper side assembly machine, 6 refers to feeding portion, 7 refers to material tube, 8 refers to pushing device, 9 refers to solution cavity, 10 refers to electromagnetic stirring device, 11 refers to mounting frame, 12 refers to mounting groove, 13 refers to sliding table, 14 refers to driving oil cylinder, 15 refers to ladder, 16 refers to frame body, 17 refers to access plate, 18 refers to control cabinet, and 19 refers to injection plug head.

### DETAILED DESCRIPTION OF PREFERRED EMBODIMENTS

To make the objectives, technical solutions and advantages of the present invention clearer, the present invention is further described in detail hereinafter with reference to the drawings and embodiments. It should be understood that specific embodiments described herein are only used for explaining the present invention, and are not intended to limit the present invention.

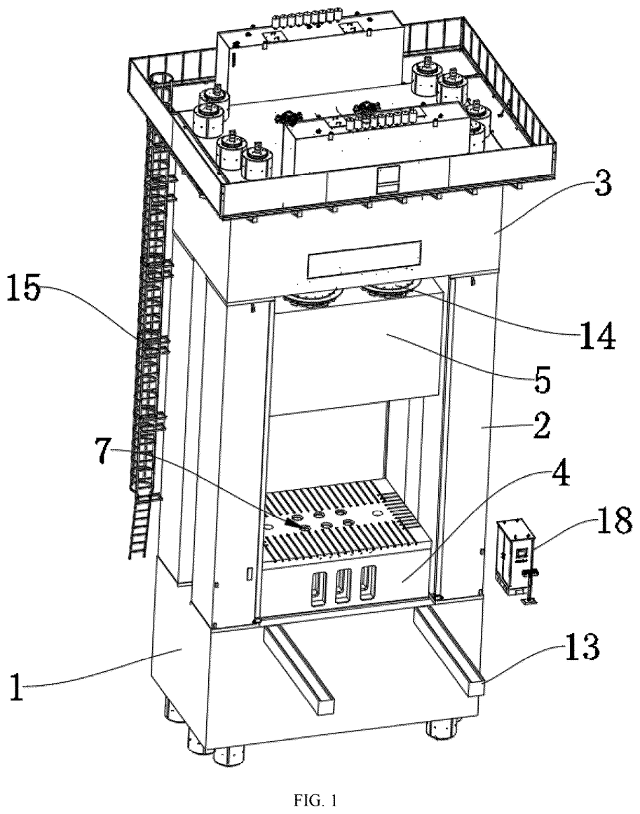

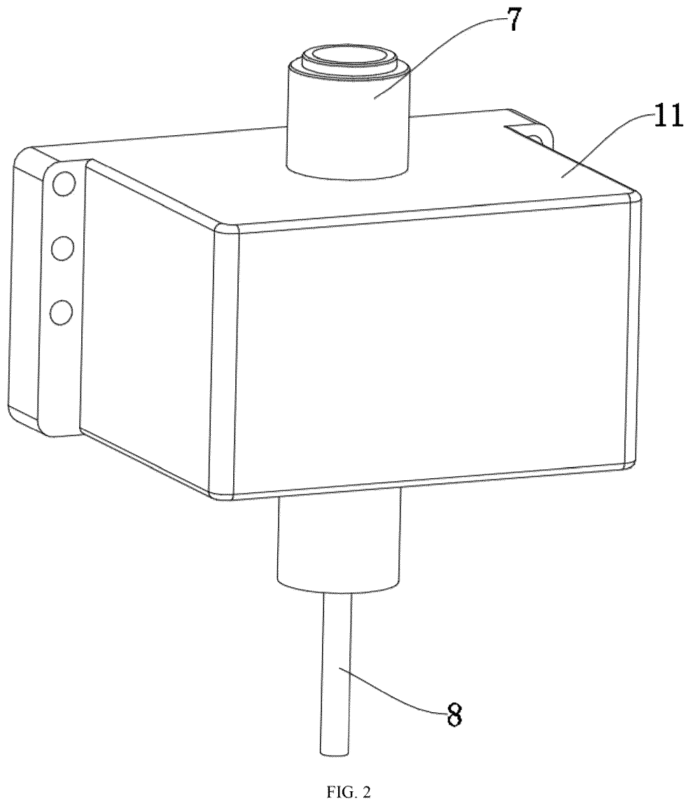

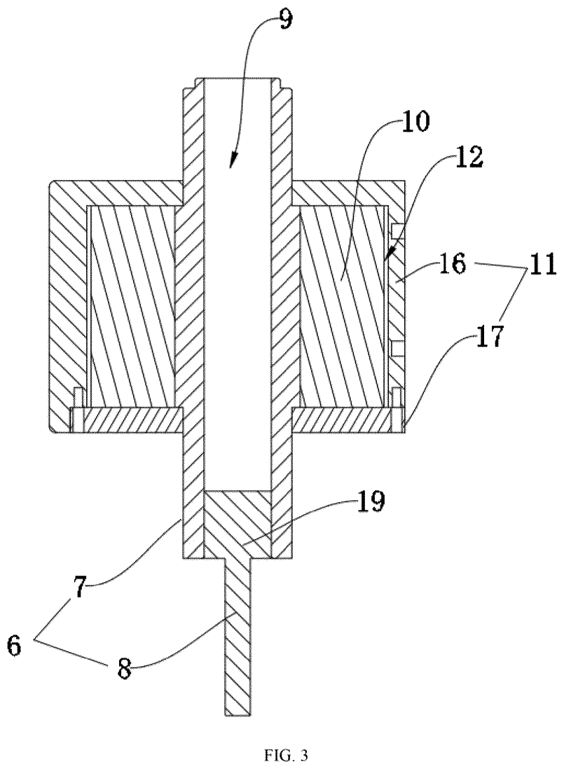

FIG. 1 to FIG. 3 show the embodiments of the present invention.

### Embodiment 1

A vertical molding machine comprises a bottom base 1, a supporting beam 2 and a top base 3, wherein an upper end of the supporting beam 2 is connected with the top base 3, a lower end of the supporting beam is connected with the bottom base 1, an upper side of the bottom base 1 is connected with a lower side assembly machine 4, a lower side of the top base 3 is connected with an upper side assembly machine 5, the upper side assembly machine 5 and the lower side assembly machine 4 are matched for pressing a mold, a plurality of feeding portions 6 are arranged in the lower side assembly machine 4, the feeding portion 6 is communicated with an upper side of the lower side assembly machine 4 through a material tube 7, at least one ladling manipulator for filling a liquid material into the feeding portion 6 is mounted on a side surface of the bottom base 1, and at least one ladle is mounted on each ladling manipulator. By such arrangement, when some large-scale products need to be processed, the plurality of feeding portions 6 may be arranged in the lower side assembly machine 4, and meanwhile, in cooperation with a plurality of ladling manipulators and a plurality of ladles, the feeding portions 6 can be filled with the liquid material at the same time through the plurality of ladles, so that a temperature of the liquid material in each feeding portion 6 is the same, without a temperature difference caused by a time difference. By arranging the feeding portion 6 on the bottom base 1, the mold can be injected with the material from bottom to top, so that air will not be wrapped in the material, and air pores generated in a molded product are reduced. Further, the plurality of feeding portions 6 inject the material into the mold at the same time, which is equivalent to dividing the mold into small areas for filling, and a pressure is more uniform. Compared with one feeding portion 6, the plurality of feeding portions make the filling of the liquid material easier.

The feeding portion 6 comprises the material tube 7 and a material pushing device 8, the material pushing device 8 is arranged in the material tube 7 in an up-down sliding manner, the material tube 7 is provided with a solution cavity 9 on an upper side of the material pushing device 8, and an upper end of the material tube 7 is communicated with an upper side of the lower side assembly machine 4. By such arrangement, before injecting the material into the mold, the liquid material is injected into the solution cavity 9 through the ladling manipulator, then a feed inlet of the mold is aligned with the upper end of the material tube 7 for mounting, and the liquid material in the solution cavity 9 is injected into the mold through the material pushing device 8 to complete casting. By arranging an electromagnetic stirring device, the liquid material in the solution cavity 9 can be stirred well, so that ingredients of the liquid material are mixed more evenly. The material pushing device 8 may drive the liquid material in the solution cavity 9 to enter the mold by a thrust of a screw or a plunger.

At least one electromagnetic stirring device 10 is mounted on the material tube 7, the electromagnetic stirring device 10 is mounted on the material tube 7 through a mounting frame 11, the mounting frame 11 is sleeved on an outer wall of the material tube 7 through a mounting hole, a hole wall of the mounting hole is provided with a mounting groove 12 around the material tube 7, the electromagnetic stirring device 10 is an annular electromagnetic stirrer, and the annular electromagnetic stirrer is sleeved on the outer wall of the material tube 7 in the mounting groove 12. By such arrangement, the annular electromagnetic stirrer can be stably fixed on the outer wall of the material tube 7 through the mounting frame 11, so that the liquid material in the solution cavity 9 can be fully stirred by the annular electromagnetic stirrer. By arranging the mounting groove 12, the mounting stability of the annular electromagnetic stirrer is improved.

### Embodiment 2

On the basis of Embodiment 1, the lower side assembly machine 4 is slidably mounted on the upper side of the bottom base 1 through a sliding table 13, and one end of the sliding table 13 extends to an outer side of the bottom base 1. By arranging the sliding table 13, the lower side assembly machine 4 can be conveniently pulled out of the outer side of the bottom base 1 for mold loading and unloading, and the like.

The upper side assembly machine 5 is connected with the top base 3 through a driving oil cylinder 14, the driving oil cylinder 14 is arranged in the top base 3, and an output end of the driving oil cylinder 14 penetrates through the top base 3 downwards and is connected with an upper side of the upper side assembly machine 5. By such arrangement, the upper side assembly machine 5 can be well driven to move up and down between the bottom base 1 and the top base 3 by the oil cylinder 14, so as to cooperate with the lower side assembly machine 4 to press and remove the mold.

A side surface of a body of the molding machine is provided with a ladder 15, and the driving oil cylinder 14, the material pushing device 8, the electromagnetic stirring device 10 and the ladling manipulator are all controlled by a control cabinet 18. By arranging the ladder 15, maintenance personnel may conveniently go to the upper side of the top base 3 for maintenance. By arranging the control cabinet 18, operators may conveniently control the driving oil cylinder 14, the material pushing device 8, the electromagnetic stirring device 10 and the ladling manipulator. The driving oil cylinder 14, the material pushing device 8, the electromagnetic stirring device 10 and the ladling manipulator may all be connected with the control cabinet 18 in a wired control or wireless control manner.

The mounting frame 11 comprises a frame body 16 and an access plate 17 which are detachably connected, the mounting groove 12 is arranged on the frame body 16, and the access plate 17 is detachably connected with the frame body 16 on an upper side or a lower side of the frame body 16 for forming an upper groove wall or a lower groove wall of the mounting groove 12. By arranging the access plate 17, maintenance personnel may conveniently repair or replace the annular electromagnetic stirrer in the mounting groove. The access plate 17 may be fixed on the upper side or the lower side of the frame body 16 by bolted connection.

A material pushing control module is arranged in the control cabinet 18, the material pushing device 8 comprises an injection plug head 19 arranged in the material tube 7 in an up-down sliding manner and a driving assembly connected to a lower portion of the material pushing device 8, and the material pushing control module is in wired or wireless signal connection with the driving assembly; and the driving assembly comprises a screw motor or a plunger pump. The material pushing control module may control an upward pushing speed and time of the injection plug head 19 under driving of the driving assembly by sending a control signal, for example, a sliding speed of the injection plug head 19 in the material tube 7 under pushing of the screw of the screw motor is controlled by controlling a rotation speed of the screw motor, so as to control a material pushing speed. Each material pushing device 8 corresponds to one material tube 7, and when there are a plurality of material tubes 7 and a plurality of material pushing devices 8, the driving assembly of each material pushing device 8 may be controlled through the material pushing control module, so as to realize sequential feeding, different speed feeding, linkage feeding and the like of the plurality of pushing devices 8. In this way, the filling of the injected material is more stable, for example, a low speed at a thin wall part of the product may lead to too fast solidification, and the driving assembly may drive the injection plug head 19 to realize a faster material injection speed through the material pushing control module, so that the thin wall part is easier to be fully filled, thus producing the high-quality product. The material pushing control module may be integrated into a main control system in the control cabinet 18, or separately mounted in the control cabinet 18.

Although the present invention is described herein with reference to several explanatory embodiments of the present invention, it should be understood that many other modifications and implementations may be designed by those skilled in the art, and these modifications and implementations will fall within the scope and spirit of the principle disclosed in the present application. More specifically, within the scope of the disclosures, the drawings and the claims of the present application, various variations and improvements may be made to the components and/or layouts of the combination layout of the subject. Besides the variations and improvements of the components and/or layouts, other uses will be obvious to those skilled in the art.

We claim:

1. A vertical molding machine, comprising a bottom base (1), a supporting beam (2) and a top base (3), wherein an upper end of the supporting beam (2) is connected with the top base (3), a lower end of the supporting beam is connected with the bottom base (1), an upper side of the bottom base (1) is connected with a lower side assembly machine (4), a lower side of the top base (3) is connected with an upper side assembly machine (5), the upper side assembly machine (5) and the lower side assembly machine (4) are matched for pressing a mold, a plurality of feeding portions (6) are arranged in the lower side assembly machine (4), the feeding portion (6) is communicated with an upper side of the lower side assembly machine (4) through a material tube (7), at least one ladling manipulator for filling a liquid material into the feeding portion (6) is mounted on a side surface of the bottom base (1), and at least one ladle is mounted on each ladling manipulator.

2. The vertical molding machine according to claim 1, wherein the feeding portion (6) comprises the material tube (7) and a material pushing device (8), the material pushing device (8) is arranged in the material tube (7) in an up-down sliding manner, the material tube (7) is provided with a solution cavity (9) on an upper side of the material pushing device (8), and an upper end of the material tube (7) is communicated with an upper side of the lower side assembly machine (4).

3. The vertical molding machine according to claim 2, wherein at least one electromagnetic stirring device (10) is mounted on the material tube (7), the electromagnetic stirring device (10) is mounted on the material tube (7) through a mounting frame (11), the mounting frame (11) is sleeved on an outer wall of the material tube (7) through a mounting hole, a hole wall of the mounting hole is provided with a mounting groove (12) around the material tube (7), the electromagnetic stirring device (10) is an annular electromagnetic stirrer, and the annular electromagnetic stirrer is sleeved on the outer wall of the material tube (7) in the mounting groove (12).

4. The vertical molding machine according to claim 1, wherein the lower side assembly machine (4) is slidably mounted on the upper side of the bottom base (1) through a sliding table (13), and one end of the sliding table (13) extends to an outer side of the bottom base (1).

5. The vertical molding machine according to claim 1, wherein the upper side assembly machine (5) is connected with the top base (3) through a driving oil cylinder (14), the driving oil cylinder (14) is arranged in the top base (3), and an output end of the driving oil cylinder (14) penetrates through the top base (3) downwards and is connected with an upper side of the upper side assembly machine (5).

6. The vertical molding machine according to claim 5, wherein a side surface of a body of the molding machine is provided with a ladder (15), and the driving oil cylinder (14), the material pushing device (8), the electromagnetic stirring device (10) and the ladling manipulator are all controlled by a control cabinet (18).

7. The vertical molding machine according to claim 3, wherein the mounting frame (11) comprises a frame body (16) and an access plate (17) which are detachably connected, the mounting groove (12) is arranged on the frame body (16), and the access plate (17) is detachably connected with the frame body (16) on an upper side or a lower side of the frame body (16) for forming an upper groove wall or a lower groove wall of the mounting groove (12).

8. The vertical molding machine according to claim 6, wherein a material pushing control module is arranged in the control cabinet (18), the material pushing device (8) comprises an injection plug head (19) arranged in the material tube (7) in an up-down sliding manner and a driving assembly connected to a lower portion of the material pushing device (8), and the material pushing control module is in wired or wireless signal connection with the driving assembly; and the driving assembly comprises a screw motor or a plunger pump.
